(19) United States
(12) Patent Application Publication
(10) Pub. No.: US 2017/0175692 A1
(43) Pub. Date: Jun. 22, 2017

(54) APPLICATION SPECIFIC FUEL FILTER

(71) Applicant: K&N Engineering, Inc., Riverside, CA (US)

(72) Inventors: Steve Williams, Beaumont, CA (US); Gilbert Heck, Nuevo, CA (US)

(73) Assignee: K&N Engineering, Inc., Riverside, CA (US)

(21) Appl. No.: 15/376,505

(22) Filed: Dec. 12, 2016

Related U.S. Application Data
(60) Provisional application No. 62/270,521, filed on Dec. 21, 2015.

(51) Int. Cl. F02M 37/22; B01D 35/00; B01D 29/31

(52) U.S. Cl. CPC F02M 37/22; B01D 29/31; B01D 35/005; B01D 2201/12

(57) ABSTRACT

An apparatus and a method are provided for an application specific fuel filter that is configured to prevent particulates from entering the fuel system of a motor vehicle, the fuel filter comprising a hollow canister comprising a length and diameter; a first end comprising a fuel inlet; a second end comprising a fuel outlet; a filter element comprising a plurality of pleats; and a rolled seam.

### PRIORITY

This application claims the benefit of and priority to U.S. Provisional Application, entitled “Application Specific Fuel Filter,” filed on Dec. 21, 2015 and having application Ser. No. 62/270,521.

### FIELD

The field of the present disclosure generally relates to motor vehicles filtering systems. More particularly, the field of the invention relates to an apparatus and a method for an application specific fuel filter.

### BACKGROUND

A fuel filter is generally configured to filter dirt and various particles from fuel. Conventionally, the fuel filter is comprised of cartridges containing a filter paper that are found in most motor vehicles. Unfiltered fuel may contain several kinds of contamination, for example paint chips and dirt that may have been knocked into a fuel tank while filling, or rust caused by moisture in a steel tank. If these substances are not removed before the fuel enters a fuel system, the substances will cause rapid wear and failure of fuel system components, including for example a motor vehicle's fuel pump and injectors. This failure is generally due to the abrasive properties of the particles with respect to these high-precision components.

Fuel filters may also improve engine performance of a motor vehicle, as the fewer contaminants present in the fuel, the more efficiently it can be burnt. The fuel filter's primary purpose is to improve the fuel pump's performance by filtering various deposits from the gasoline being transferred to the engine of the motor vehicle. As the fuel pump supplies gas to the engine, the fuel filter serves as a barrier, ensuring that only gas of an acceptable purity is pumped into the engine. Consequently, the fuel filter eliminates much of the contamination in the fuel, protecting the fuel pump and fuel injectors as gas is supplied to the engine.

It is generally desirable to maintain fuel filters at regular intervals, via replacement with a new filter, for example. Replacing the fuel filter generally requires disconnecting the filter from the fuel line and replacing it with a new one, although some specially designed filters may be cleaned and reused many times.

If a fuel filter is not replaced at the manufacturer's recommended service interval it could become clogged and cause enough restriction in the fuel flow to reduce engine performance or struggle to maintain normal operation. Additionally, use and regular maintenance of a fuel filter can maintain factory performance and fuel economy. The less restriction found in the fuel system, and fewer contaminants, the more efficiently an engine can run.

Typically, fuel filters are positioned between a motor vehicle's fuel pump and fuel injectors. Due to its installation location, the exterior of the fuel filter may come into contact with various road debris that could damage the fuel filter.

What is needed, therefore, is a device and a method for an application specific fuel filter that has increased strength, reliability and capacity such that foreign materials are prevented from being supplied to an engine, thereby protecting a motor vehicle's fuel system.

### BRIEF DESCRIPTION OF THE DRAWINGS

The drawings refer to embodiments of the present disclosure in which:

FIG. 1 illustrates a perspective view of an embodiment of a fuel filter disposed in an exemplary fuel circuit of a motor vehicle, according to the present disclosure;

FIG. 2 illustrates a perspective view of an embodiment of an exemplary fuel filter suitable for low pressure systems such as carburetors, according to the present disclosure;

FIG. 3 illustrates a cut-away view of an embodiment of an exemplary fuel filter, suitable for high pressure systems, such as fuel injection systems, according to the present disclosure; and

FIG. 4 illustrates a side view of an embodiment of an exemplary application specific fuel filter, according to the present disclosure.

While the present disclosure is subject to various modifications and alternative forms, specific embodiments thereof have been shown by way of example in the drawings and will herein be described in detail. The invention should be understood to not be limited to the particular forms disclosed, but on the contrary, the intention is to cover all modifications, equivalents, and alternatives falling within the spirit and scope of the present disclosure.

### DETAILED DESCRIPTION

In the following description, numerous specific details are set forth in order to provide a thorough understanding of the present disclosure. It will be apparent, however, to one of ordinary skill in the art that the invention disclosed herein may be practiced without these specific details. In other instances, specific numeric references such as “first end,” may be made. However, the specific numeric reference should not be interpreted as a literal sequential order but rather interpreted that the “first end” is different than a “second end.” Thus, the specific details set forth are merely exemplary. The specific details may be varied from and still be contemplated to be within the spirit and scope of the present disclosure. The term “coupled” is defined as meaning connected either directly to the component or indirectly to the component through another component. Further, as used herein, the terms “about,” “approximately,” or “substantially” for any numerical values or ranges indicate a suitable dimensional tolerance that allows the part or collection of components to function for its intended purpose as described herein.

In general, the present disclosure describes an apparatus and a method for an application specific fuel filter to prevent introduction of various particulates from entering the fuel system of a motor vehicle. The fuel filter comprises a hollow canister having a length and a diameter, and a first end comprising a fuel inlet and a second end comprising a fuel outlet. A central pipe is disposed in the canister such that the fuel inlet and fuel outlet are in fluid communication. A filter medium is disposed in the canister so as to trap particulates from entering a motor vehicle's fuel system. It is contemplated that embodiments of the fuel filters discussed herein will be configured so as to replace a motor vehicle's factory fuel filter, if the motor vehicle is so equipped. Preferably, the fuel filter canister is made from high-strength carbon steel and powder coated for corrosion resistance. The high efficient, high capacity designs as discussed herein are rated for substantially 80 gallons per hour flow rates. It is contemplated that the fuel filters described herein comprise SAE J2044 compliant connectors. Finally, the fuel filters described herein may be used in conjunction with gas and diesel engines, regardless of the fuel that is utilized. For example, applications utilizing gasoline, ethanol, and/or various combinations are supported.

In one embodiment, an application specific fuel filter is disclosed and configured so as to prevent particulates from entering the fuel system of a motor vehicle, the fuel filter comprising: a hollow canister comprising a length and diameter; a first end comprising a fuel inlet; a second end comprising a fuel outlet; a filter element comprising a plurality of pleats; and a rolled seam. In another embodiment, the fuel inlet comprises a threaded arrangement that is configured to fasten and receive a fuel line. In one embodiment, the core pipe is disposed in the center of the canister, such that it is in fluid communication with the fuel inlet and the fuel outlet. In one embodiment, the core pipe comprises a exit point at its center, so as to allow fuel to be filtered. In another embodiment, the canister comprises a unitary construction, such that it sealingly engages with a bottom plate at the first end. In yet another embodiment, the first and second ends comprise of plates that sealingly engage with the canister. In one embodiment, the rolled seam is disposed at the first end.

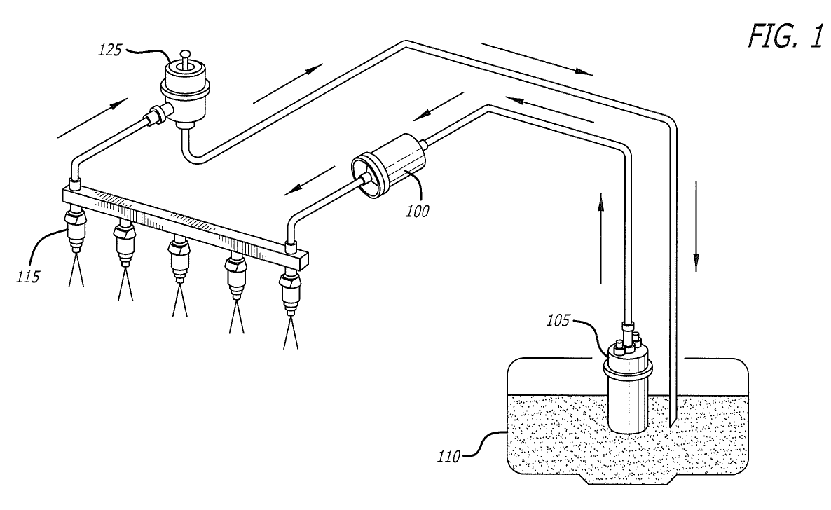

FIG. 1 illustrates a perspective view of an embodiment of a fuel filter disposed in an exemplary fuel circuit of a motor vehicle, according to the present disclosure. In one embodiment, a fuel pump 105 is disposed inside the fuel tank 110. Fuel is pumped from the fuel tank 110, through an exemplary fuel filter 100, and to the plurality of injectors 115 by way of a fuel line. A fuel pressure regulator 125 on the fuel line is configured so as to ensure that the plurality of injectors 115 receive a constant fuel pressure. When fuel exits the injectors 115, the excess is returned to the tank by way of a return line. Consequently, it is to be understood that this closed loop fuel supply guarantees a consistent spray and amount of fuel from each of the injectors 115.

It is to be understood that although the fuel pump 105 is a frequently used component in a fuel system, it is not necessarily required. For example, many engines do not require any fuel pump at all, and only require gravity to feed fuel from the fuel tank through a line or hose to the engine. However, in non-gravity feed designs, fuel must be pumped from the fuel tank 110 to the engine and delivered under certain pressure to a carburetor (low pressure) or a fuel injection system (high pressure), depending on the system. Often, carbureted systems comprise low pressure mechanical pumps that are mounted outside the fuel tank 110, whereas fuel injected engines often use electric fuel pumps that are mounted inside the fuel tank. Finally, some fuel injected systems comprise two fuel pumps, such that one low pressure/high volume supply pump is disposed in the fuel tank and one high pressure/low volume pump is disposed on or near the engine.

The plurality of fuel injectors 115 may be generally configured as a spring-loaded solenoid pintle valve for example, without limitation. When energized by a motor vehicle's computer, the fuel injector's solenoid pulls the valve open, thereby allowing fuel to spray out of the nozzle and into the engine. When the computer cuts the circuit that powers the injector, the valve inside the injector snaps shut and fuel delivery stops. The total amount of fuel delivered is controlled by cycling injector voltage on and off very rapidly. It is to be understood that the longer the pulse width, the greater the volume of fuel delivered and the richer the fuel mixture. Decreasing the duration of the injector signal pulse reduces the volume of fuel delivered and leans out the mixture, which may or may not be desirable given a particular motor vehicle's configuration.

The fuel pressure regulator 125 is configured so as to restrict the return of fuel to the fuel tank 110 by a calibrated amount in order to maintain desired fuel pressure. If the calibrated system pressure is exceeded, excess fuel will be permitted to return to the fuel tank 110.

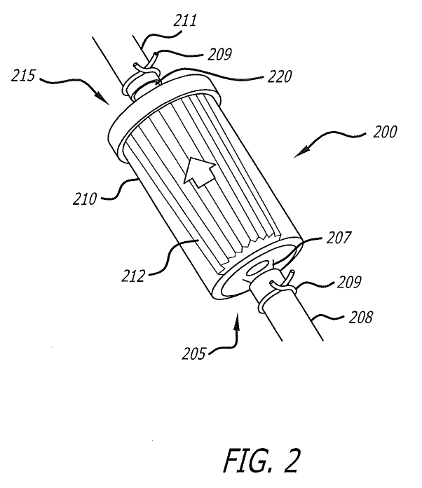

FIG. 2 illustrates a perspective view of an embodiment of an exemplary fuel filter suitable for low pressure systems such as carbureted systems, according to the present disclosure. As shown, the fuel filter 200 generally comprises a hollow canister 210 comprising a length and a diameter. A filter element 212 is disposed in the hollow canister 210, wherein the filter element 212 may comprise nearly any shape, including for example, conical, cylindrical, or any combination thereof, without limitation. The fuel filter 200 comprises a first end 205 wherein a fuel inlet 207 is disposed. As shown, a first fuel line 208 may be coupled with the fuel inlet 207, such that the first fuel line 208 is in fluid communication with the fuel filter 200.

A retaining mechanism 209 such as a clamp, or any other various fastener may be used without limitation so as to retain the first fuel line 208 with the fuel inlet 207. Similarly, the fuel filter 200 comprises a second end 215, wherein a fuel outlet 220 is disposed. Preferably, the fuel outlet 220 is configured so as to be in fluid communication with a second fuel line 211 that couples the fuel filter 200 to the plurality of fuel injectors 115, for example. The second end 215 may also comprise a retaining mechanism 209 so as to retain the second fuel line 211 with the fuel outlet 220. The first and second fuel lines 208, 211 may comprise a hose-like shape, and may be comprised of any suitable material, including for example rubber, plastic, metal, etc. without limitation.

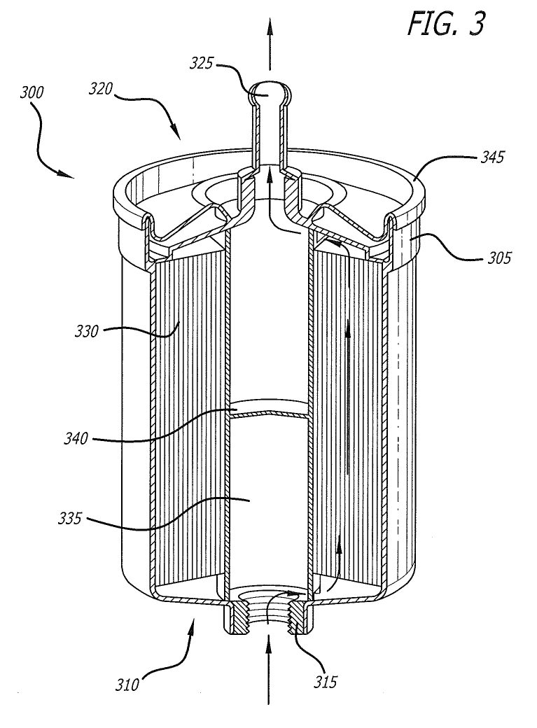

FIG. 3 illustrates a cut-away view of an embodiment of an exemplary fuel filter, suitable for high pressure systems, such as fuel injection systems, according to the present disclosure. As shown, the fuel filter 300 generally comprises a hollow canister 305 comprising a length and a diameter. Preferably, the hollow canister 305 comprises high strength material, such as carbon steel, for example. The fuel filter 300 comprises a first end 310 wherein a fuel inlet 315 is disposed. The fuel inlet 315 may be molded to a bottom portion of the fuel filter 300. In some embodiments, the fuel inlet 315 may comprise a threaded arrangement that is configured to fasten and receive a fuel line. Similarly, the fuel filter 300 comprises a second end 320, wherein a fuel outlet 325 is disposed.

As shown in FIG. 3, a filter element 330 is disposed inside the hollow canister 305 of the fuel filter 300. Preferably, the filter comprises a high-performance cellulose glass media that is configured to prevent particulates from entering a motor vehicle's fuel system. The filter element 330 may comprise of pleated paper, foam, cotton, spun fiberglass, or other suitable filter materials alone or in combination, without limitation. In one embodiment, the filter element 330 comprises substantially the entire interior area of the hollow canister 305. As shown, the filter element 330 includes core pipe 335 that is preferably disposed in the center of the hollow canister 305 such that it is in fluid communication with the fuel inlet 315 and the fuel outlet 325. The core pipe 335 comprises a exit point 340 at its center, so as to allow fuel to be filtered. The exit point 340 may be placed at various locations depending on the fuel filter's configuration. Preferably, the hollow canister 305 comprises a unitary construction, such that it sealingly engages with a bottom plate at the first end 310. In one embodiment, both the first and second ends 310, 320 comprise of plates that may sealingly engage with the hollow canister 305. Preferably, a rolled seam 345 is disposed at either the first end 310 or second end 320 that is configured to exceed conventional pressure requirements.

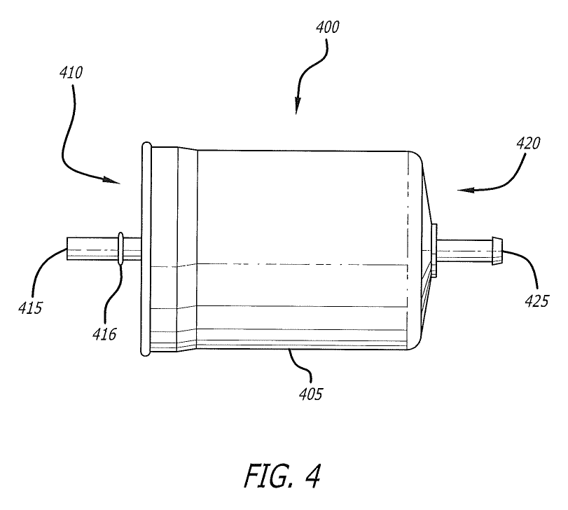

FIG. 4 illustrates a side view of an embodiment of an exemplary application specific fuel filter, according to the present disclosure. The fuel filter 400 comprises a generally hollow canister 405 that comprises a length and a diameter that is variable depending on the application. For example, it is to be appreciated that various automobile manufacturers produce various types of vehicles, and as a result, the dimensions of the fuel filter 400 must be modified accordingly. In some applications, the fuel filter 400 may be placed under the hood of a motor vehicle, and as a result, hood clearance and space in the engine compartment may be a limiting factor. Similarly, the fuel filter 400 may be disposed underneath the body of the motor vehicle, and as such, clearance with respect to the road, for example, may be an issue.

As shown, the fuel filter 400 generally comprises a hollow canister 405 comprising a length and a diameter. Preferably, the hollow canister 405 comprises high strength material, such as carbon steel, for example. The fuel filter 400 comprises a first end 410 wherein a fuel inlet 415 is disposed. The fuel inlet 415 may be molded to a bottom portion of the fuel filter 400. In some embodiments, the fuel inlet 415 may comprise a threaded arrangement that is configured to fasten and receive a fuel line. Similarly, the fuel filter 400 comprises a second end 420, wherein a fuel outlet 425 is disposed. As shown, the fuel inlet 415 and outlet 425 are generally configured in an annular fashion and extend longitudinally so as to be coupled with fuel lines as discussed herein. In one embodiment, a ring 416 is disposed on the fuel inlet 415 so as to retain a fuel line.

While the invention has been described in terms of particular variations and illustrative figures, those of ordinary skill in the art will recognize that the invention is not limited to the variations or figures described. In addition, where methods and steps described above indicate certain events occurring in certain order, those of ordinary skill in the art will recognize that the ordering of certain steps may be modified and that such modifications are in accordance with the variations of the invention. Additionally, certain of the steps may be performed concurrently in a parallel process when possible, as well as performed sequentially as described above. To the extent there are variations of the invention, which are within the spirit of the disclosure or equivalent to the inventions found in the claims, it is the intent that this patent will cover those variations as well. Therefore, the present disclosure is to be understood as not limited by the specific embodiments described herein, but only by scope of the appended claims.

1. An application specific fuel filter that is configured to prevent particulates from entering the fuel system of a motor vehicle, the fuel filter comprising:
a hollow canister comprising a length and diameter;
a first end comprising a fuel inlet;
a second end comprising a fuel outlet;
a filter element comprising a plurality of pleats; and
a rolled seam.

2. The fuel filter of claim 1, where the fuel inlet comprises a threaded arrangement that is configured to fasten and receive a fuel line.

3. The fuel filter of claim 1, wherein a core pipe is disposed in the center of the canister, such that it is in fluid communication with the fuel inlet and the fuel outlet.

4. The fuel filter of claim 3, wherein the core pipe comprises a exit point at its center, so as to allow fuel to be filtered.

5. The fuel filter of claim 1, wherein the canister comprises a unitary construction, such that it sealingly engages with a bottom plate at the first end.

6. The fuel filter of claim 1, wherein the first and second ends comprise of plates that sealingly engage with the canister.

7. The fuel filter of claim 1, wherein the rolled seam is disposed at the first end.
